(19) United States
(12) Patent Application Publication
(10) Pub. No.: US 2025/0259242 A1
(43) Pub. Date: Aug. 14, 2025

(54) INFORMATION PROCESSING DEVICE

(71) Applicant: TOYOTA JIDOSHA KABUSHIKI KAISHA, Toyota-shi (JP)

(72) Inventor: Atsushi HIGAKI, Tokyo (JP)

(73) Assignee: TOYOTA JIDOSHA KABUSHIKI KAISHA, Toyota-shi (JP)

(21) Appl. No.: 18/437,657

(22) Filed: Feb. 9, 2024

(30) Foreign Application Priority Data
May 23, 2023 (JP) 2023-084538

(51) Int. Cl. G06Q 40/08

(52) U.S. Cl. CPC G06Q 40/08

(57) ABSTRACT

In the information processing device, the control unit receives an input of information including the remaining price of the first vehicle in use by the user, the remaining bond of the first vehicle, the monthly insurance premium of the first vehicle, the delivery date of the second vehicle that the user desires to transfer, and the vehicle type of the third vehicle that can be used in the cancellation fee free plan, and calculates the payment amount in a case where it is assumed that the third vehicle is used until the delivery date of the second vehicle. The control unit outputs information including the calculated payment amount.

### CROSS-REFERENCE TO RELATED APPLICATION

This application claims priority to Japanese Patent Application No. 2023-084538 filed on May 23, 2023, incorporated herein by reference in its entirety.

### BACKGROUND

### 1. Technical Field

The present disclosure relates to an information processing device.

### 2. Description of Related Art

A technique for promoting sales of a vehicle is known (see, for example, Japanese Unexamined Patent Application Publication No. 2005-227977 (JP 2005-227977 A)).

### SUMMARY

An object of the present disclosure is to provide a technique capable of suppressing a decrease in a user's desire to replace a vehicle when the delivery time of a vehicle with which the user desires to replace is long.

One aspect of the present disclosure is an information processing device. The information processing device in this case includes, for example, a control unit configured to execute:
receiving input of information including a residual value of a first vehicle used by a user, a remaining debt of the first vehicle, a monthly insurance premium of the first vehicle, a delivery date of a second vehicle with which the user wishes to replace, and a vehicle category of a third vehicle that the user is able to use by paying a usage fee of a fixed amount every month and is able to cancel at any timing without paying a cancellation fee;
calculating, in response to the input of the information, a payment amount assuming that the third vehicle is used until the delivery date of the second vehicle; and
outputting the payment amount.

The present disclosure can also be regarded as an information processing method in which a computer executes processing of the information processing device. The present disclosure can also be regarded as an information processing program for causing a computer to execute the information processing method or a non-transitory storage medium storing the information processing program.

According to the present disclosure, it is possible to provide a technique capable of suppressing a decrease in a user's desire to replace a vehicle when the delivery time of a vehicle with which the user desires to replace is long.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration example of a system according to an embodiment;

FIG. 2 is a diagram illustrating a first exemplary supporting Web;

FIG. 3 is a diagram illustrating a second embodiment of a supporting Web page; and

FIG. 4 is a flowchart illustrating a processing flow executed by the server according to the embodiment.

### DETAILED DESCRIPTION OF EMBODIMENTS

In a sales service or a leasing service of a new vehicle, there is a so-called transfer in which a vehicle (first vehicle) currently used by a user is taken out and a new vehicle (second vehicle) is purchased or leased. Incidentally, it is also assumed that the delivery date of the second vehicle is one year or more from six months. In such a case, the user may not be able to use the vehicle for a long period of time from taking the first vehicle out to the delivery date of the second vehicle. Further, although it is conceivable that the user continues to use the first vehicle until the delivery date of the second vehicle, there is a possibility that the maintenance cost of the first vehicle is unnecessary or the amount of the first vehicle withdrawn is lowered. These circumstances may reduce the user's willingness to transfer to the second vehicle. As a result, there is a possibility that the user may transfer to a vehicle or a used vehicle of another manufacturer. Therefore, in a case where the delivery date of the second vehicle is long, it is necessary to make an effort to suppress a decrease in the user's willingness to transfer to the second vehicle.

Therefore, in the information processing device according to the present disclosure, the control unit receives input of information including the remaining price of the first vehicle used by the user, the remaining bond of the first vehicle, the monthly insurance premium of the first vehicle, the delivery date of the second vehicle that the user desires to transfer, and the vehicle type of the third vehicle that can be used by the user paying a fixed usage fee every month and that can be cancelled at an arbitrary timing without paying a cancellation fee. In this case, the control unit may output a user interface screen including an input field of the remaining price of the first vehicle, an input field of the remaining bond of the first vehicle, an input field of the monthly insurance premium of the first vehicle, an input field of the delivery date of the second vehicle that the user desires to transfer, and an input field of the vehicle type of the third vehicle.

Here, the remaining debt of the first vehicle is the remaining amount of the outstanding debt, when the user has completed repaying the debt and when the user has completed the payment collectively at the time of purchase of the first vehicle, as the remaining debt of the first vehicle “0” may be input.

Upon receiving the input of the above-described information, the control unit calculates a payment amount in a case where it is assumed that the third vehicle is used until the delivery date of the second vehicle. As an example, the control unit calculates the amount of payment by the following procedure.
(1) A first month number, which is a number of months until the delivery date of the second vehicle, is multiplied by the monthly insurance premium of the 1 vehicle, and the 1 amount of money is calculated
(2) The remaining price of a first vehicles is added to a first amount of money, and the second amount of money is calculated
(3) The balance of a first vehicles is subtracted from a second amount of money, and the third amount of money is calculated
(4) By dividing the third amount by the usage fee of the third vehicle, the second month calculation
(5) By subtracting the second number of months from the first month, the third number of months calculated
(6) By multiplying the 3 number of months by the usage fee of the 3 vehicles, the payment amount is calculated

Here, the third amount of money corresponds to the amount of money to be refunded to the user in a case where it is assumed that the first vehicle is withdrawn at the present time. The second number of months is the number of months in which the third vehicle can be used in the refund amount. The third number of months is the number of months in which the user needs to pay the usage fee of the third vehicle at the user's takeout, assuming that the third vehicle is used until the delivery date of the second vehicle. When the second number of months is larger than the first number of months, the control unit sets the payment amount to “O” without performing the calculation of the third number of months.

When the payment amount is calculated by the above-described procedure, the control unit outputs the calculated payment amount. Here, when the information processing device according to the present disclosure is a terminal used by a selling service of a new vehicle and/or an operator providing a leasing service, outputting the payment amount may include outputting an interface screen including the payment amount. Further, when the information processing device according to the present disclosure is a Web server connected to the terminal of the business operator through a network, outputting the payment amount may include causing an interface screen (Web page) including the payment amount to be output to a browser of the terminal.

According to the information processing device of the present disclosure, the operator can propose to the user that the third vehicle can be used at the payment amount until the delivery date of the second vehicle.

Here, in the lease service, the contract period is set to a predetermined fixed period (for example, about 36 months to 60 months), and when the contract is cancelled in the middle of the contract period, the user is obliged to pay the cancellation money. Therefore, if the number of months (the first number of months) until the delivery date of the second vehicle is shorter than the predetermined period, it is necessary for the user to cancel the lease contract on the way by paying the cancellation fee.

On the other hand, the third vehicle can be used by the user paying a flat usage fee every month, and can be cancelled at an arbitrary timing without paying a cancellation fee. Therefore, even if the user cancels the contract of the third vehicle in accordance with the delivery date of the second vehicle, the user is not obliged to pay the cancellation money.

Therefore, the operator can appeal to the user that the third vehicle can be used without requiring payment of the cancellation fee until the delivery date of the second vehicle, and that the refund amount corresponding to the trade-in of the first vehicle can be applied to the usage fee of the third vehicle. As a result, even in a case where the delivery date of the second vehicle is relatively long, it is possible to suppress a decrease in the user's willingness to transfer to the second vehicle.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

Embodiments of the present disclosure will be described with reference to the drawings. In the present embodiment, an example in which the information processing device according to the present disclosure is applied to a system that provides a sales service and a lease service of a vehicle will be described.

### System Configuration

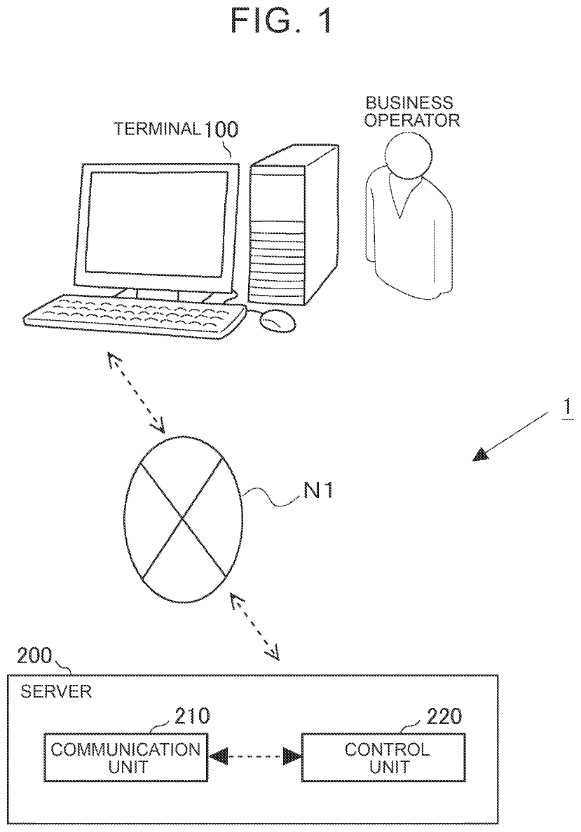

FIG. 1 is a block diagram schematically illustrating a configuration example of a system 1 according to the present embodiment. The system 1 according to the present embodiment includes a terminal 100 and a server 200. In the example shown in FIG. 1, only one terminal 100 is shown, but a plurality of terminals 100 may be included in the system 1.

The terminal 100 is a terminal used by a business operator (for example, an employee of a car dealer) who performs a sales business and a lease business of a vehicle. The terminal 100 is, for example, a computer on which a browser application program is installed, such as a smartphone, a mobile phone, a tablet terminal, a wearable device, or a personal computer. In the present embodiment, the operator acquires the support information by accessing the server 200 through the terminal 100. The support information is information that supports a proposal made by an operator to a user who wishes to transfer to a vehicle having a relatively long delivery date (for example, a vehicle having a delivery date of six months to one year or more). The term “proposal” as used herein means proposing to transfer a vehicle that is different from the vehicle in question until the delivery date of the vehicle that the user desires to transfer.

In the present embodiment, the vehicle currently used by the user is referred to as a first vehicle, the vehicle that the user desires to transfer from the first vehicle is referred to as a second vehicle, and the vehicle that can transfer to the delivery date of the second vehicle is referred to as a third vehicle. The third vehicle is a vehicle (for example, a vehicle provided by a subscription service) that can be used by a user paying a fixed usage fee (monthly usage fee) every month and can be cancelled at an arbitrary timing without paying a cancellation fee.

Next, the server 200 is an information processing device operated by a company (for example, a manufacturer of a new vehicle or an affiliated company of a manufacturer) that entrusts sales and leasing of a new vehicle to a business operator. The servers 200 can be configured as computers having processors, such as CPU or GPU, main storage devices, such as RAM and ROM, and secondary storage devices, such as EPROM, hard disk drives, or removable media. The secondary storage device of the servers 200 stores an operating system (OS), various programs, various tables, and the like. The processor of the server 200 loads a program stored in the auxiliary storage device into a work area of the main storage device and executes the program, thereby realizing each function that matches a predetermined purpose, as will be described later. However, some or all of the functions of the servers 200 may be realized by hardware circuitry such as Application Specific Integrated Circuit (ASIC) or Field Programmable Gate Array (FPGA).

The server 200 in the present embodiment is configured to be capable of implementing a Web server for interacting with the terminal 100. The server 200 interacts with the terminal 100 through Web server to provide the operator with information that supports the transfer of the vehicles of the user. Note that the server 200 may provide the above-described services by means other than Web server. For example, a service that interacts with dedicated application software installed in the terminal 100 according to a predetermined protocol may be executed in the server 200.

As illustrated in FIG. 1, the server 200 that realizes the above-described functions includes a communication unit 210 and a control unit 220.

The communication unit 210 is a communication interface for connecting the servers 200 to a network N1. The communication unit 210 connects to a network N1 through, for example, a LAN or Wi-Fi (registered trademark), and communicates with the terminal 100 through a network N1. The network N1 is, for example, a WAN or another communication network that is a global public communication network such as the Internet.

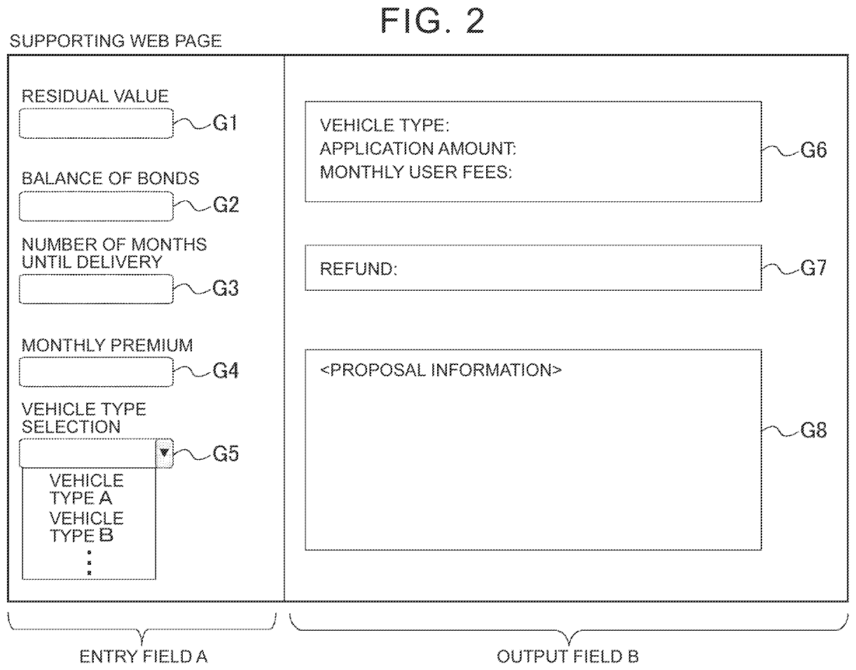

The control unit 220 is a software module realized by the processor of the server 200 executing a program stored in the auxiliary storage device. The control unit 220 interacts with the terminal 100 through executing Web servers. In the present embodiment, the control unit 220 displays the supporting Web page on the browser of the terminal 100. FIG. 2 is a diagram illustrating a first embodiment of a supporting Web page. As shown in FIG. 2, the supporting Web page includes an input field A and an output field B.

The input field A is a field for inputting information related to the transfer of the user, and includes the following input items.
(Input-item 1) Remaining price of first vehicles (GUI part G1 in FIG. 2)
(Input-item 2) The amount of remaining debt of the first vehicles (GUI part G2 in FIG. 2)
(Entry 3) Number of months until delivery date of second vehicles (GUI part G3 in FIG. 2)
(Input-item 4) Monthly premium of the first vehicles (GUI part G4 in FIG. 2)
(Input-item 5) 3rd vehicle type selection (GUI part G5 in FIG. 2)

The output field B is a field for outputting support information corresponding to the input contents of the input items 1 to 5, and includes the following output items.
(Output-Item 1) Third Vehicle Information (GUI Component G6 in FIG. 2)
(Output-item 2) The amount of refund according to the trade-in of the first vehicles (GUI part G7 in FIG. 2)
(Output-item 3) Proposal data (G8 Of GUI components in FIG. 2)

Note that, until the input of the input item 1-5 in the input field A is completed, each of the output items 1-3 in the output field B becomes blank as shown in FIG. 2.

When the operator inputs information to each of the input items 1-5 on the supporting Web page, the control unit 220 generates information to be displayed in the output field B. Specifically, information displayed in the output item 1 (G5 in FIG. 2) is generated according to the vehicle type (vehicle type of the third vehicle) input in the input field 5 (G5 in FIG. 2). In an example, the information displayed in the output item 1 may include a vehicle type of the third vehicle, an application amount and a monthly usage fee when the third vehicle is used in a plan (hereinafter, sometimes referred to as a “cancellation fee free plan”) that can be cancelled at an arbitrary timing without paying a cancellation fee. These pieces of information may be stored in a database connected to the secondary storage device of the server 200 or the server 200 through a network N1 for each type of vehicle that can be used in the cancellation money free plan among the types of vehicles handled by the business operator.

In addition, the control unit 220 calculates the amount of refund to the user when it is assumed that the first vehicle has been withdrawn at the present time in accordance with the information input in the input item 1 (G1 in FIG. 2), the input item 2 (G2 in FIG. 2), the input item 3 (G3 in FIG. 2), and the input item 4 (G4 in FIG. 2). In an example, the control unit 220 calculates a refund amount according to the following procedure.
(Procedure 1) The month amount insurance premium of a first vehicles is multiplied by the month number (first month number) by the delivery date of a second vehicles, and the first amount of money is calculated
(Procedure 2) Add the balance of a first vehicles to a first amount of money, and calculate the second amount of money
(Procedure 3) The balance of a first vehicles is subtracted from the second amount of money, and the 3rd amount of money is calculated

The remaining value of the first vehicle is set based on the evaluation value in the market. In an example, the vehicle type, the grade, the body color, the year, the travel distance, and the like may be set to be equal to an actual evaluation value in the market for the same vehicle as the first vehicle. Here, the “market” is, for example, a market for used cars. The remaining amount of the first vehicle is the remaining amount of the current outstanding borrowing of the borrowing at the time of purchase of the first vehicle. Note that when the user has repaid the borrowing at the present time and when the user has finished paying in a lump sum at the time of purchasing the first vehicle, “O” is input to the input item 2 (G2 in FIG. 2).

The control unit 220 sets the third amount of money calculated in accordance with the above-described procedure 1-3 to a refund amount in a case where it is assumed that the first vehicle has been withdrawn at the present time.

Further, the control unit 220 generates information (proposal information) to be displayed in the output item 3 (G8 in FIG. 2) according to the third amount of money calculated in step 3, the first number of months input in the input item 3 (G3 in FIG. 2), and the vehicle type (vehicle type of the third vehicle) input in the input item 5 (G5 in FIG. 2). In one example, the suggestion information may include a second number of months, a third number of months, and a payment amount. The second number of months is the number of months in which the monthly usage fee of the third vehicle becomes free by appropriating the refund amount (third amount) out of the number of months (first number of months) until the delivery date of the second vehicle. The third number of months is a difference between the first number of months and the second number of months (the number of months until the delivery date of the second vehicle (the first number of months), the monthly usage fee of the third vehicle is the number of months to be charged). The payment amount is a total amount when it is assumed that the monthly usage fee of the third vehicle is paid for the third number of months.

The second number of months, the third number of months, and the payment amount are calculated by the following procedure.
(Procedure 4) By dividing the third amount of money by the monthly usage fee of the third vehicle, the second number of months is calculated
(Procedure 5) Subtract the second number of months from the first number of months, and calculate the third number of months
(Procedure 6) Calculate the amount of payment by multiplying the 3rd month number by the month amount of the third vehicle

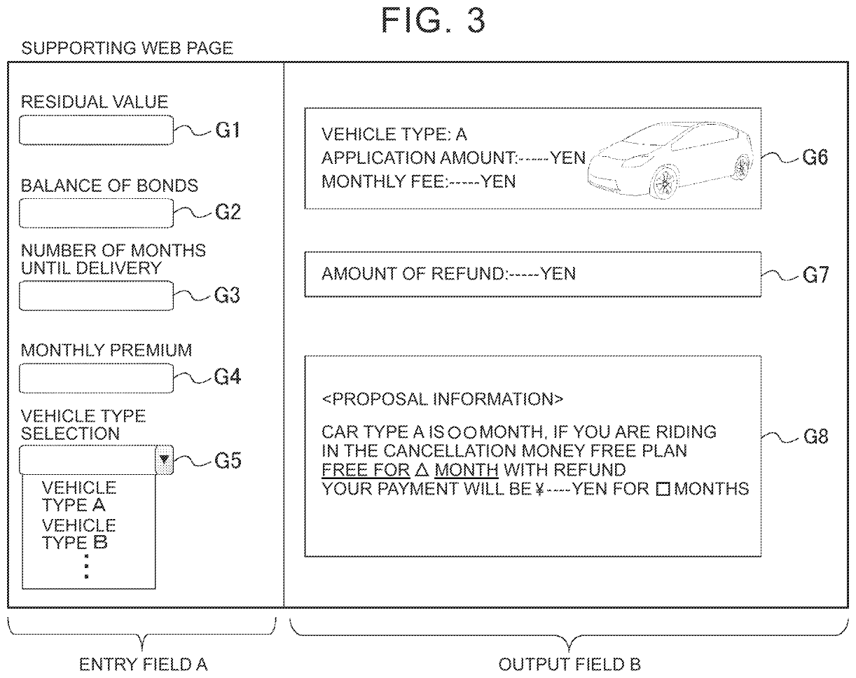

When the information displayed in the output field B is generated in the above-described manner, as shown in FIG. 3, the control unit 220 causes the generated information to be displayed in each of the output item 1 (G6 in FIG. 3), the output item 2 (G7 in FIG. 3), and the output item 3 (G7 in FIG. 3) of the output field B. As a result, the operator can grasp the suggested information to the user by looking at the supporting Web page as shown in FIG. 3.

Note that the configuration of the supporting Web page is not limited to that shown in FIGS. 2 and 3, and the input/output items can be flexibly changed according to the embodiment. In addition, the input field A and the output field B do not need to be displayed on the same Web page, but may be displayed on separate Web pages.

### Processing Flow

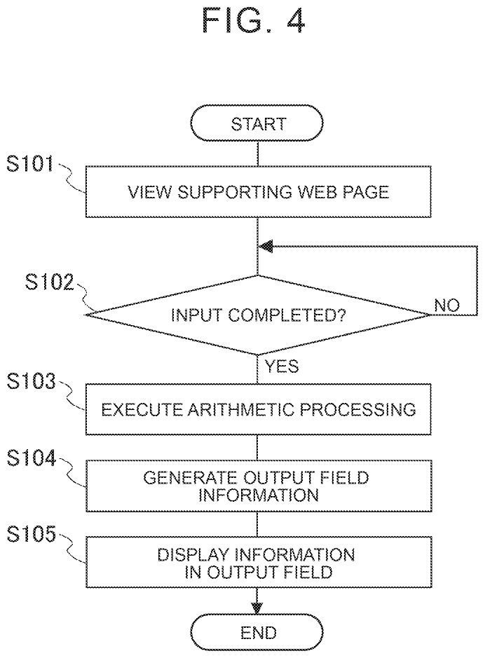

A processing flow executed by the server 200 according to the present embodiment will be described with reference to FIG. 4. FIG. 4 is a flow chart showing a process routine executed by the servers 200 triggered by the operator accessing URL of the supporting Web page through the web browser of the terminal 100. The execution subject of the processing routine of FIG. 4 is the processor of the server 200, and the software module of the server 200 is described as the execution subject.

When the operator accesses URL of the support Web page through the web browser of the terminal 100, the control unit 220 of the server 200 causes the web browser of the terminal 100 to display a support Web page (see FIG. 2) in which the output field B is blank (S101). Upon completion of S101 process, the control unit 220 executes S102 process.

In S102, the control unit 220 determines whether the input of the input items 1 to 5 in the input field A of the supporting Web page has been completed. When the input of the input item 1-5 is not completed (negative determination in S102), the control unit 220 waits until the input of the input item 1-5 is completed. When the input of the input items 1-5 is completed (affirmative determination is made by S102), the control unit 220 executes S103 process.

In S103, the control unit 220 calculates a third amount of money (refund amount), a second number of months, a third number of months, and a payout amount. The calculation of the third amount, the second number of months, the third number of months, and the payment amount is performed according to the following procedure 1-6, as described above.
(Procedure 1) The month amount insurance premium of a first vehicles is multiplied by the month number (first month number) by the delivery date of a second vehicles, and the first amount of money is calculated
(Procedure 2) Add the balance of a first vehicles to a first amount of money, and calculate the second amount of money
(Procedure 3) The balance of a first vehicles is subtracted from the second amount of money, and the third amount of money (refund) is calculated
(Procedure 4) By dividing the third amount of money by the monthly usage fee of the third vehicle, the second number of months is calculated
(Procedure 5) Subtract the second number of months from the first number of months, and calculate the third number of months
(Procedure 6) Calculate the amount of payment by multiplying the 3rd month number by the month amount of the 3rd vehicle

The control unit 220 executes S104 process when the third amount of money (refund amount), the second number of months, the third number of months, and the payment amount are calculated. In S104, the data displayed in each of the output items 1-3 in the output field B is generated. Specifically, the control unit 220 generates information displayed in the output item 1 (G5 in FIG. 3) according to the vehicle type (vehicle type of the third vehicle) input in the input field 5 (G5 in FIG. 2). In addition, the control unit 220 generates information displayed in the output-item 2 (G6 in FIG. 3) according to the third amount of money (refund amount) calculated by S103. Further, the control unit 220 generates information (proposal information) to be displayed in the output-item 3 (G8 in FIG. 3) according to the second number of months, the third number of months, and the payment amount calculated by S103. The control unit 220 executes S105 process after completing the data displayed in each of the output items 1-3 in the output field B.

In S105, the control unit 220 causes the supporting Web page (see FIG. 3) in which the information generated by S104 is displayed in the output field B to be displayed through the web browser of the terminal 100. When S105 processing is finished, the control unit 220 ends the execution of this processing routine.

### Operation and Effect of Embodiments

In the above-described embodiment, when the delivery date of the second vehicle that the user desires to transfer is long, the operator can receive the presentation of the proposal information by accessing the server 200 through the web browser of the terminal 100. Accordingly, the operator can appeal to the user that the third vehicle can be used in the cancellation fee-free plan until the delivery date of the second vehicle based on the proposal information presented from the server 200, and that the payment amount for the use of the third vehicle can be suppressed to a low amount by appropriating the refund amount corresponding to the trade-in of the first vehicle to the usage fee of the third vehicle. As a result, even in a case where the delivery date of the second vehicle is relatively long, it is possible to suppress a decrease in the user's willingness to transfer to the second vehicle.

In the present embodiment, the server 200 corresponds to an “information processing device” according to the present disclosure. The control unit 220 of the server 200 corresponds to a “control unit” according to the present disclosure. Further, the supporting Web page according to the present disclosure corresponds to the “interface screen” according to the present disclosure.

### OTHER EMBODIMENTS

The above-described embodiment is merely an example, and the present disclosure can be appropriately modified and implemented without departing from the gist thereof. For example, processing performed by the server 200 may be performed by the terminal 100. That is, the terminal 100 may perform the output of the interface screen including the input field A and the output field B, the calculation of the refund amount, the calculation of the second number of months, and the calculation of the third number of months through the execution of the dedicated application program. In this case, the terminal 100 corresponds to an “information processing device” according to the present disclosure. Further, the processor of the terminal 100 executes a dedicated application program to achieve the “control unit” according to the present disclosure.

Also, the processes and the configurations described in the present disclosure can be appropriately combined to be implemented as long as no technical contradiction occurs. Moreover, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to execute:
receiving input of information including a residual value of a first vehicle used by a user, a remaining debt of the first vehicle, a monthly insurance premium of the first vehicle, a delivery date of a second vehicle with which the user wishes to replace, and a vehicle category of a third vehicle that the user is able to use by paying a usage fee of a fixed amount every month and is able to cancel at any timing without paying a cancellation fee;
calculating, in response to the input of the information, a payment amount assuming that the third vehicle is used until the delivery date of the second vehicle; and
outputting the payment amount.

2. The information processing device according to claim 1, wherein calculating the payment amount includes:
multiplying the number of first months that is the number of months until the delivery date of the second vehicle by the monthly insurance premium of the first vehicle, and calculating a first amount of money;
adding the residual value of the first vehicle to the first amount of money, and calculating a second amount of money;
subtracting the remaining debt of the first vehicle from the second amount of money, and calculating a third amount of money;
calculating the number of second months by dividing the third amount of money by the usage fee of the third vehicle;
subtracting the number of the second months from the number of the first months, and calculating the number of third months; and
calculating the payment amount by multiplying the number of the third months by the usage fee of the third vehicle.

3. The information processing device according to claim 2, wherein outputting the payment amount includes outputting a user interface screen including the number of the second months, the number of the third months, and the payment amount.

4. The information processing device according to claim 1, wherein receiving the input of the information includes outputting a user interface screen including an input field of the residual value of the first vehicle, an input field of the remaining debt of the first vehicle, an input field of the monthly insurance premium of the first vehicle, an input field of the delivery date of the second vehicle, and an input field of the vehicle category of the third vehicle.
